(19) United States
(12) Patent Application Publication
(10) Pub. No.: US 2008/0137030 A1
(43) Pub. Date: Jun. 12, 2008

(54) OPTICAL DEVICES WITH REDUCED CHROMATIC ABERRATION

(76) Inventor: William C. HOFFMAN, Lakewood, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/934,188

(22) Filed: Nov. 2, 2007

Related U.S. Application Data
(60) Provisional application No. 60/864,236, filed on Nov. 3, 2006.

(51) Int. Cl. G02C 7/10

(52) U.S. Cl. 351/163; 351/177

(57) ABSTRACT

This invention relates to an optical device such as a soft or rigid contact lens, intra ocular lens (IOL), ocular insert, or spectacle lens that improves visual acuity by reducing chromatic aberration. Chromatic aberration is reduced by filtering or blocking ultraviolet and high energy blue/violet light below about 455 nm and red and infrared light above about 655 nm. This is accomplished by including in the polymer formulations blue/violet absorbing colorants and ultraviolet light absorbers to filter or block light below about 455 nm; and red absorbing colorants and infrared absorbers to filter or block light above about 655 nm. When these materials are used for wavefront designed lenses, vision better than 20/20 is attainable.

### CROSS-REFERENCE TO RELATED APPLICATIONS

This application claims priority to U.S. provisional patent application Ser. No. 60/864,236, filed Nov. 3, 2006, which is incorporated by reference to the extent not inconsistent with the disclosure herewith.

### BACKGROUND OF THE INVENTION

This invention relates to an optical device such as a soft or rigid contact lens, intra ocular lens (IOL), ocular insert, or spectacle lens that improves visual acuity by reducing chromatic aberration. The human eye is able to detect wavelengths of light from 380 to 780 nm with optimal sensitivity at 555 nm. When green light at 555 nm is perfectly focused on the retina, blue/violet light at 380 nm and red light at 780 nm are out of focus. Blue light focuses in front of the retina while red light focuses behind the retina. This chromatic aberration has been called “blue blurr” or “chromatic blurr”. An eye with 20/20 vision at 555 nm can be 20/30 or higher in the far blue or far red regions of the optical spectrum. When out of focus light is reduced or blocked, visual acuity is enhanced and objects appear much sharper. The effect is most pronounced in the red region, since the eye is more sensitive to red light than blue. Previous investigators have concentrated primarily on blocking ultraviolet and blue light, ignoring the red and near infrared region. The previous efforts were designed to prevent damage to the eye from energetic ultraviolet and blue light. Ultraviolet light is a known cause of cataract formation and blue light has been implicated as a cause of senile macular degeneration, night blindness and snow blindness.

Tinting of contact lenses began with the first polymethyl methacrylate (PMMA) contact lenses in the 1960s. Lenses were tinted to aid in location of the lens and to provide minor enhancement of eye color. PMMA lenses are still offered in a myriad of colors in many shades. Practically all rigid lenses available today are tinted. Many soft hydrogel lenses are tinted a very light color to aid in visibility. Practically all rigid gas permeable (RGP) contact lenses are also tinted.

In 1971 Zeltzer (U.S. Pat. No. 3,586,423; 4,998,817) described a red contact lens for the purpose of increasing color perception in color blind individuals. The lens described contains colorants that block light up to 600 nm.

In 1981, Loshaek (U.S. Pat. Nos. 4,304,895; 4,390,676; RE 33,477) described soft and rigid contact lenses containing an ultraviolet light absorber to block harmful rays for patients, particularly after cataract extraction. The lenses also contained red and yellow colorants to block light in the 340 to 450 nm range. Loshaek teaches the use of a polymerizable ultraviolet light absorber that cannot be extracted from a soft hydrogel contact lens.

In 1984, Su (U.S. Pat. No. 4,468,229) disclosed a soft contact lens and method of tinting with reactive dyes. Reactive dyes chemically react with the lens surface and cannot be extracted. These tinted lenses are used cosmetically to enhance the color of the eye.

In 1988, Hoffman and coworkers patented (U.S. Pat. No. 4,733,959) a method of tinting soft hydrogel lenses in bulk with reactive or vat dyes.

In 1990, Stevens (U.S. Pat. No. 4,952,046; RE 38,402) patented a lens that blocks ultraviolet and blue light up to 515 nm. The lens is claimed to improve visual acuity and substantially reducing eye damage in bright sunlight environments. Both spectacle and contact lenses are described that contain a colorant that absorbs the ultraviolet and blue light. Stevens claims that the elimination of ultraviolet light can help reduce the formation of cataracts and the reduction of blue light can help avoid senile macular degeneration. There are several commercial products, such as Blue-Blocker® and SunTiger® sunglasses and contact lenses, as well as the Nike Maxsight® contact lens (made by Bausch and Lomb) based on this idea.

In 1993, Mutzhas, et al. (U.S. Pat. No. 5,235,358) disclosed a similar lens with a cut-off in the 450 to 550 nm region claimed to improve vision.

In 1998, Hoffman patented (U.S. Pat. Nos. 5,617,154; 5,846,457) lenses and a method of producing light filtering contact lenses. US FDA approved dyes are used to tint contact lenses to filter or block light at particular wavelengths.

Also in the 1990s, there are a number of patents that claim reduction in chromatic aberration with lenses made from birefringent materials (U.S. Pat. No. 5,017,000) or aspheric lenses with diffractive optics (U.S. Pat. Nos. 4,641,934; 4,642,112; 5,117,306), or lenses with refractive index gradients (U.S. Pat. No. 6,089,711).

More recently a number of patents (U.S. Pat. Nos. 6,786,603; 6,817,714) describe devices known as aberrometers that use wavefront technology to accurately measure all physical aberrations of the complete optical system of the eye. These instruments were developed primarily to aid in refractive surgery. For example, Alcon's Ladarvision®, introduced in 2002, uses an integrated system coupling a wavefront measuring device to an excimer laser. The aberrations are expressed mathematically as Zernike polynomials. New computer controlled lathes are capable of producing optical lenses (contact lenses, IOLs, or spectacle lenses) that can correct these aberrations. Theoretically, since these lenses can correct all of the physical aberrations of the eye's optical system, vision better than 20/20 should be attainable. However, this procedure does not account for chromatic aberration, making it impossible to achieve the limit of 20/08 vision with currently available lens materials.

In 2001, Gordon (U.S. Pat. No. 6,224,211) describes a “super vision” contact lens where spherical aberrations are corrected with an aspheric contact lens design. The aspheric curve is determined from a set of trial lenses. 20/15 to 20/08 vision is claimed.

In 2002, Williams et al. (U.S. Pat. No. 6,338,559) discusses the need to correct both higher-order monochromatic and chromatic aberrations to improve visual performance. The higher-order aberrations are corrected by contact lenses or IOLs having the appropriate surface shapes determined by aberrometry. Chromatic aberration is corrected by light amplitude modification or artificial apodization. This can be done by varying the density of a colorant across the optical zone, increasing density from the center to the edge; or with concentric annular rings of increasing color density.

In 2006, Legerton et al. (U.S. Pat. Nos. 7,104,648; 7,104,648) disclose a hybrid contact lens with a rigid central zone surrounded by a soft hydrogel skirt.

There is a need in the art for an optical device having reduced chromatic aberration.

### SUMMARY OF THE INVENTION

Provided is an optical device comprising a polymeric matrix material and at least one spectral blocking material, wherein the spectral blocking material(s) provide a desired radiation transmittance characteristic to the optical device.

More specifically, provided is a lens comprising: a polymeric matrix material; and at least one spectral blocking material, wherein the lens blocks transmission of light below 455 nm and above 655 nm. Also provided is a method of making an optical device as described here. Also provided is a method of providing visual acuity greater than 20/20 comprising providing a lens to a user, wherein the lens comprises a polymeric matrix material and at least one spectral blocking material, wherein the optical device blocks transmission of light below 455 nm and above 655 nm.

As used herein, “optical device” includes soft or rigid contact lens, intra ocular lens, ocular insert, spectacle lens, and any other device which is placed in, on or around the eye, or through which an optical measurement is made. In one embodiment, optical device comprises soft or rigid contact lens, intra ocular lens, ocular insert, and spectacle lens and is intended for human or animal use. Unless otherwise indicated, as used herein, “lens” and “optical device” are used interchangeably. The materials from which optical devices are made are known in the art. All such materials which can be modified by the present invention are intended to be included in this disclosure to the extent as if they were individually and collectively listed. For example, hard contact lenses typically comprise an essentially hydrophobic polymeric matrix material (typically poymethyl methacrylate, PMMA, or a methyl methacrylate copolymer). Soft contact lenses typically comprise a hydrophilic matrix polymer. These and other materials may form the polymeric matrix material. The spectral blocking materials may be incorporated into the polymeric matrix material at any suitable point in the fabrication process, such as prior to polymerization, during polymerization, or after polymerization.

In one embodiment, the spectral blocking materials visually tint the entire lens or a portion or portions thereof. One or a mixture of spectral blocking materials may be used to provide the desired optical properties. Different spectral blocking materials may be positioned in different portions of the optical device to produce the desired effect, as described here. In accordance with this embodiment, stabilization means for nonrotationally orienting the optical device (on the eye, for example) may be included, as known in the art. Other art known translational movement means which cause the lens to move (or be restrained from) upward or downward or other directional movement may be included in an embodiment of the invention, as known in the art.

In addition to spectral blocking materials as described here, other additives may be added to the optical devices described here. These additives are known in the art and may be used to assist in the preparation or formation of the optical device, to improve the stability or strength of the optical device, or for other purposes as desired and known to one of ordinary skill in the art without undue experimentation. In addition, materials may be used during the fabrication process, such as initiators (such as benzoyl peroxide, lauryl peroxide, azobis(isobutyronitrile), 2,2′-azobis(2,4-dimethyl-4-methoxypropionitrile), and 2,2′-azobis(2-methylpropionitrile)), and crosslinking agents (such as ethylene glycol dimethacrylate, triethylene, glycol dimethacrylate, trimethylolpropane trimethacrylate or other di-functional or multi-functional monomer or mixture thereof). Additives may also include materials which improve oxygen permeability (such as trifluoroethyl methacrylate and 3-methacryloxyproplytris (trimethylsilyl)siloxane)) and/or wetting.

In addition to the spectral blocking material(s), colorants may be added which provide a desired end product color, and which may or may not contribute to the desired optical properties. Spectral blocking materials may be polymerizable or nonpolymerizable. The word “color” includes white, black and grey, as well as other hues. Spectral blocking materials used herein are materials which alter the spectra transmittance curve of the material, as opposed to materials which opacify a material. Spectral blocking materials may be colored, or may provide color to the end product.

As used herein, “blocking” or “filtering” the transmission of light does not necessarily that there is no optical transmittance, but rather, a reduced light transmission at wavelengths indicated. In one embodiment, the transmittance using a spectral blocking material is lowered from the situation where a spectral blocking material is not used. In one embodiment, blocked or filtered means there is essentially zero optical transmission at specified wavelengths. In one embodiment, light that is blocked or filtered has a less than 50% transmission. In one embodiment, light that is blocked or filtered has a less than 40% transmission. In one embodiment, light that is blocked or filtered has a less than 30% transmission. In one embodiment, light that is blocked or filtered has a less than 20% transmission. In one embodiment, light that is blocked or filtered has a less than 10% transmission. All individual values and subranges of transmission are intended to be included. As used herein, “light” includes all wavelengths, including UV, visible and IR.

### BRIEF DESCRIPTION OF THE FIGURES

FIG. 1 shows the optical spectra of materials from several patent documents. Note that all materials shown absorb ultraviolet, blue and even green light; but none absorb red or infrared light. This chart also shows an exemplary spectrum of materials disclosed here.

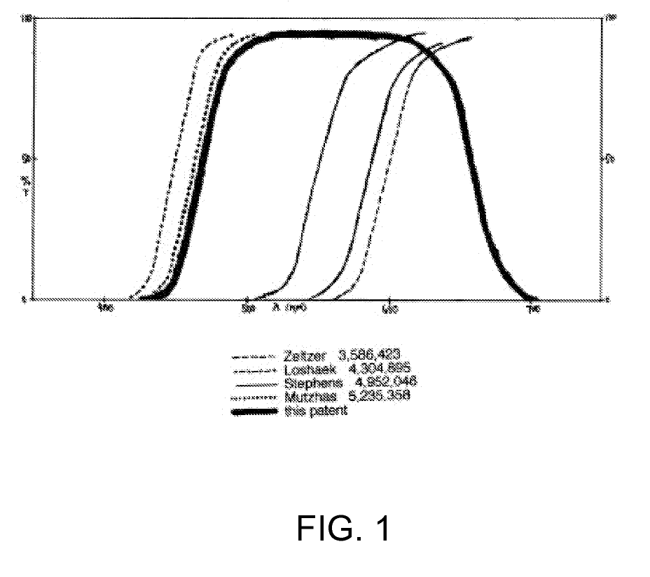

FIG. 2 shows the optical spectrum of the material produced from Example 1.

FIG. 3 shows the optical spectrum of the material produced from Example 2.

### DETAILED DESCRIPTION OF THE INVENTION

The following description provides nonlimiting examples of some embodiments of the invention.

The invention described in this patent application relates to optical devices such as soft or rigid contact lenses, intra ocular lenses (IOLs), ocular inserts, or spectacle lenses that improve visual acuity by reducing chromatic aberration. This is accomplished by filtering or blocking regions of the spectrum that cause the most chromatic aberration. When light at 555 nm (the wavelength with the eye's greatest sensitivity) is in focus, higher and lower wavelengths will be out of focus. The effect will be greatest at the furthest wavelengths detectable by the eye. Thus, light at 380 and 780 nm will produce the greatest chromatic aberration. To significantly improve visual acuity, light outside of a desired range around the desired wavelength must be filtered or blocked.

As will be recognized, a perfect match to the desired wavelength and transmission levels cannot always be obtained using the materials available and measurement devices available, so when a particular value is provided, it is understood and intended that a range around that value is included to the extent that each individual value and subrange are individually listed. In one embodiment, a listed wavelength value is intended to include wavelength values within ±25 nm. In one embodiment, a listed wavelength value is intended to include wavelength values within ±20 nm. In one embodiment, a listed wavelength value is intended to include wavelength values within ±10 nm. In one embodiment, a listed transmission value is intended to include transmission values within ±15%. In one embodiment, a listed transmission value is intended to include transmission values within ±10%. In one embodiment, a listed transmission value is intended to include transmission values within ±5%. It is desired that the entire spectrum of the optical device is within the provided values, however, it is recognized that there may be a small portion of the spectrum of the optical device that does not have the indicated transmission, in part because of the spectral blocking materials which are used. As long as the nonconforming portion of the spectrum of the optical device is no larger than 50 nm, the optical device is intended to be included in an embodiment of the invention described here.

In one embodiment, the optical device transmits most of the light in the 455 to 655 nm region and filters or blocks light from 200 to 455 nm and 655 to 780 nm. In one embodiment, the optical device transmits more than 50% of the light in the 455 to 655 nm region and filters or blocks light below 455 nm and above 655 nm. In one embodiment, the optical device transmits at least 70% of the light in the 455 to 655 nm region and has a transmission of less than 50% from 200 to 455 nm and 655 to 780 nm. In one embodiment, the optical device also filters or blocks light in the infrared region from 780 nm to 900 nm and beyond. It is to be understood that any wavelength range or individual value within the provided ranges can be transmitted or blocked, as is consistent with the context. Some particular ranges are provided for illustration, although it is understood the provided ranges are not intended to be limiting. In one embodiment, the optical device filters light below 455 nm and above 600 nm. In one embodiment, the optical device filters light below 500 nm and above 600 nm. In one embodiment, the optical device filters light below 400 nm and above 700 nm. In one embodiment, the optical device filters light below 350 nm and above 800 nm. In one embodiment, the optical device filters light below 380 nm and above 780 nm.

In one embodiment, light which is not within the range of 550 nm±100 nm is filtered or blocked. In one embodiment, the transmission of light which is not within the range of 550 nm±100 nm is 50% or less. In one embodiment, the transmission of light which is not within the range of 550 nm±100 nm is 60% or less. In one embodiment, the transmission of light which is not within the range of 550 nm±100 nm is 70% or less.

Although applicant does not wish to be bound by theory, the following is provided to further illustrate the invention. Ultraviolet and violet/blue light from 200 to 455 are filtered or blocked to reduce chromatic aberration, and provide protection from high-energy ultraviolet radiation. Similarly, red and infrared light from 655 to 780 nm are filtered or blocked. Wavelengths from 780 nm to 900 nm and beyond are filtered or blocked to provide protection from infrared radiation. Blocking more light will further reduce chromatic aberration, however this could cause unwanted changes in color perception. If it is assumed that the degree of chromatic aberration with the wavelength difference from 555 nm is linear, then the effect of filtering or blocking light from 380 to 455 nm and from 655 to 780 nm can be calculated. Thus, blocking light from 380 to 455 nm will reduce chromatic aberration by 43% and blocking light from 655 to 780 nm by 56%. The lens does not necessarily have to block all of the light in the 400 to 455 nm or 655 to 780 nm (or other specified) regions. By adjusting the concentrations of the blue light filtering dye and the infrared filtering dye in the lens, the amount of light filtered may be adjusted to any desired transmission value. Allowing transmission of some of the light in these regions reduces changes in color perception, however, in one embodiment, at least 50% of the light should be filtered to significantly reduce chromatic aberration. Filtering materials should be chosen to match the ideal transmission curve as closely as possible, within the limits of cost and other parameters, as known in the art.

In one embodiment, the lens contains at least one material which absorbs ultraviolet light, and at least one material which absorbs infrared light. These materials may or may not be themselves colored.

Ultraviolet light absorbers. Polymerizable ultraviolet light absorbers are used routinely in both rigid and soft hydrogel materials. One preferred ultraviolet light absorber is 2-(2′-hydroxy-5′-methacryloxyethylphenyl)-2H-benzotriazole (CAS 96478-09-0). The selection of the particular absorber or absorbers used can be made by one of ordinary skill in the art without undue experimentation using the disclosure herein.

Infrared light absorbers. Absorbers are manufactured by Epolin Incorporated; Exciton Incorporated and the H. W. Sands Corporation, for example. The selection of the particular absorber or absorbers used in this invention can be made by one of ordinary skill in the art without undue experimentation using the disclosure herein.

Epolin, Incorporated specializes in the manufacture of infrared and Laser Absorbing Dyes. They produce several infrared absorbing dyes that absorb red and infrared light. In one embodiment, a suitable dye absorbs from 655 nm to 900 nm. Dyes with absorption maxima around 750 nm will effectively filter light in the 655 to 750 nm range. In some cases, an additional infrared absorber may be used to filter wavelengths up to 900 nm and beyond. In certain embodiments, useful absorbers are platinum dithiolene, nickel dithiolene, tris ammonium or anthroquinone compounds. Epolight 9151 is an anthroquinone and Epolight 2057 is a tris ammonium compound and are examples of materials which are useful in this invention.

The H. W. Sands Corporation also supplies infrared absorbing dyes. In one embodiment, a suitable infrared absorbing dye is a metal complex that is stable in the presence of free radicals. For example, SDA5575 is a nickel complex that absorbs in the 700 to 900 nm range.

Exciton, Incorporated also manufactures infrared light absorbing dyes. IRA-735 is a metal complex dye with an absorption maximum at 735 nm and good absorption in the 655 to 750 nm range, and is an example of a useful material for use in this disclosure.

Colorants. For contact lenses and IOLs, colorants approved for contact lens use by the US FDA are preferred. Both Solvent Yellow 18 and Reactive Yellow 86 are FDA approved for contact lens use.

As is known in the art, a combination of spectral blocking materials may be used to produce the desired effect. This selection is performed without undue experimentation by one of ordinary skill in the art using the description provided here.

### EXAMPLES

### Example 1

### A PMMA (polymethyl methacrylate) contact lens or IOL material

Formulation (% by weight):

| | |
|---|---|
| MMA, methyl methacrylate monomer, polymer base | 96.9 |
| EGD, ethylene glycol dimethacrylate, crosslinker | 1.21 |
| HMEPB, UV absorber | 1.50 |
| Epolight 2057, IR absorber | 0.18 |
| Solvent Yellow 18, blue light absorber | 0.08 |
| AIBN, 2,2-azobisisobutyronitrile, initiator | 0.03 |
| V-70, 2,2′-azobis(4-methoxy-2,4-dimethylvaleronitrile), initiator | 0.10 |

HMEPB: 2-(2′-hydroxy-5′-methacryloxyethylphenyl)-2H-benzotriazole

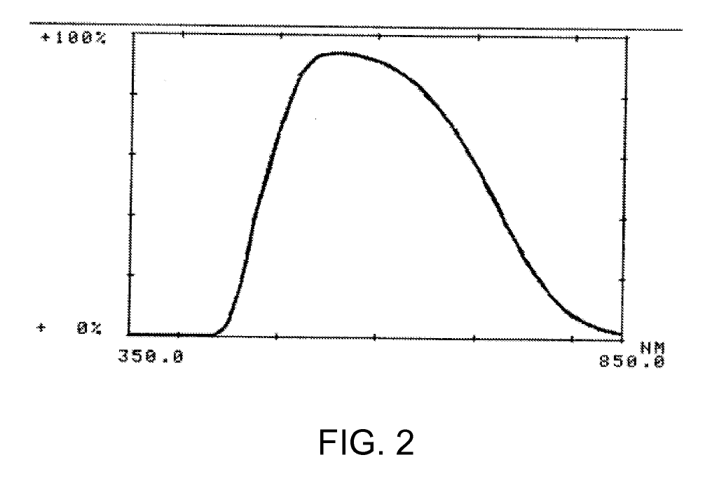

The MMA and EGD were inhibitor free. The components were stirred until dissolved, filtered and degassed. The mixture was poured into polypropylene molding tubes and the tubes capped. The tubes were placed in a water bath maintained at 20° C. for 12 hours. Polymerization occurs during this time period. The tubes were then placed in a laboratory oven at 50° C. for four hours. After cooling to room temperature, the polymer rods were removed from the molding tubes. The polymerized rods were hard and dark yellow green in color. The rods were then post cured for four hours at 75° C. followed by 12 hours at 100° C. A test disc was machined and polished. The 0.15 mm thick disc was clear and light apple green in color. The spectrum is shown in FIG. 2.

### Example 2

### A fluoro-silicone-acrylate RGP contact lens material (Dk 60)

Formulation (% by weight):

| | |
|---|---|
| MMA, methyl methacrylate monomer, polymer base | 12.0 |
| TFEM, trifluoroethyl methacrylate, oxygen permeability | 26.0 |
| EGD, ethylene glycol dimethacrylate, crosslinker | 6.08 |
| MMA, methacrylic acid, wetting agent | 6.0 |
| TRIS monomer, oxygen permeability source | 38.4 |
| TRIS dimmer, oxygen permeability and crosslinking | 9.6 |
| HMEPB, UV absorber | 1.5 |
| Epolight 9151, IR absorber | 0.18 |
| Solvent Yellow 18, blue light absorber | 0.08 |
| AIBN, 2,2-azobisisobutyronitrile, initiator | 0.04 |
| V-70, 2,2′-azobis(4-methoxy-2,4-dimethylvaleronitrile), initiator | 0.12 |

HMEPB: 2-(2′-hydroxy-5′-methacryloxyethylphenyl)-2H-benzotriazole
TRIS: 3-methacryloxypropyltris(trimethylsiloxy)silane
TRIS DIMER: 1,3-bis(3-methacryloxypropyl)tetrakis(trimethylsiloxy)disiloxane

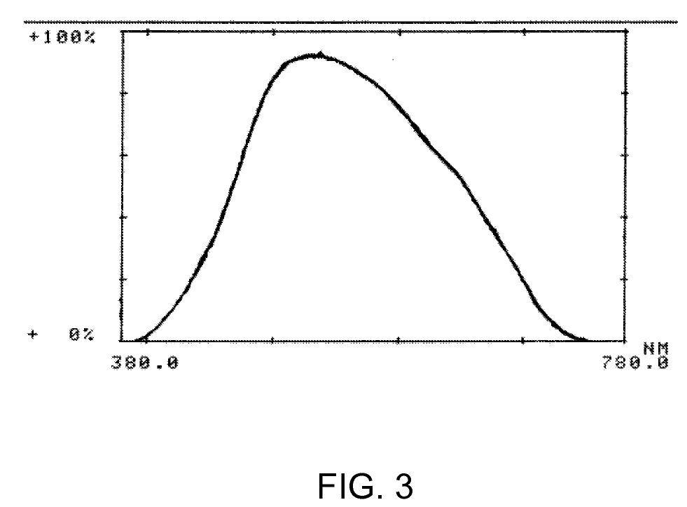

The MMA, TFEM, MM and EGD were inhibitor free. The components were stirred until dissolved, filtered and degassed. The mixture was poured into polypropylene molding tubes and the tubes capped. The tubes were placed in a water bath maintained at 20° C. for 12 hours. Polymerization occurs during this time period. The tubes were then placed in a laboratory oven at 50° C. for four hours. After cooling to room temperature, the polymer rods were removed from the molding tubes. The polymerized rods were hard and dark yellow green in color. The rods were then post cured for four hours at 75° C. followed by 12 hours at 100° C. A test disc was machined and polished. The 0.15 mm thick disc was clear and light apple green in color. The spectrum is shown in FIG. 3.

### Example 3

### A silicone-hydrogel soft contact lens material (water content 40%, Dk 75)

Formulation (% by weight):

| | |
|---|---|
| DMA, N,N-dimethylacrylamide, hydrophilic polymer base | 50.0 |
| TRIS monomer, oxygen permeability source | 30.0 |
| TFEM, trifluoroethyl methacrylate, oxygen permeability | 17.46 |
| EGD, ethylene glycol dimethacrylate, crosslinker | 0.5 |
| HMEPB, UV absorber | 1.5 |
| Epolight 91 51 , IR absorber | 0.20 |
| Reactive Yellow 86, blue light absorber | 0.10 |
| AIBN, 2,2-azobisisobutyronitrile, initiator | 0.06 |
| V-70, 2,2′-azobis(4-methoxy-2,4-dimethylvaleronitrile), initiator | 0.18 |

HMEPB: 2-(2′-hydroxy-5′-methacryloxyethylphenyl)-2H-benzotriazole
TRIS: 3-methacryloxypropyltris(trimethylsiloxy)silane

The DMA, TFEM and EGD were inhibitor free. The components were stirred until dissolved, filtered and degassed. The mixture was poured into polypropylene molding tubes and the tubes capped. The tubes were placed in a water bath maintained at 20° C. for 12 hours. Polymerization occurs during this time period. The tubes were then placed in a laboratory oven at 50° C. for four hours. After cooling to room temperature, the polymer rods were removed from the molding tubes. The polymerized rods were hard and dark yellow green in color. The rods were then post cured for four hours at 75° C. followed by 12 hours at 100° C. A test disc was machined and polished. The disc was hydrated in pH 8.5 0.9% saline at 50° C. to bind the reactive dye. The disc was then re-equilibrated in pH 7.2 0.9% saline. The 0.15 mm thick disc was clear and light apple green in color.

Formation and fitting of contact lenses using the materials described here is well within the knowledge of one of ordinary skill in the art without undue experimentation. For example, polymers are typically formed into a contact lens by polymerization in a cylindrical mold (e.g., a glass tube) followed by cutting the resulting polymer transversely into buttons, and machining the buttons into lenses. The spectral blocking materials are preferably non-extractable under normal wearing conditions of the lenses.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a wavelength range cutoff is claimed, it should be understood that wavelength range cutoffs known in the prior art, including certain wavelength range cutoffs disclosed in the references disclosed herein (particularly in referenced patent documents), are not intended to be included in the claim.

When a group of substituents is disclosed herein, it is understood that all individual members of those groups and all subgroups, including any isomers and enantiomers of the group members, and classes of compounds that can be formed using the substituents are disclosed separately. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, synthetic methods, and compositions other than those specifically exemplified can be employed in the practice of the invention without resort to undue experimentation. All art-known functional equivalents, of any such methods, device elements, starting materials, synthetic methods, and compositions are intended to be included in this invention. Whenever a range is given in the specification, for example, a wavelength range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The definitions are provided to clarify their specific use in the context of the invention.

One skilled in the art readily appreciates that the present invention is well adapted to carry out the objects and obtain the ends and advantages mentioned, as well as those inherent in the present invention. The methods, components, materials and wavelengths described herein as currently representative of preferred embodiments are provided as examples and are not intended as limitations on the scope of the invention. Changes therein and other uses which are encompassed within the spirit of the invention will occur to those skilled in the art, are included within the scope of the claims.

Although the description herein contains certain specific information and examples, these should not be construed as limiting the scope of the invention, but as merely providing illustrations of some of the embodiments of the invention. Thus, additional embodiments are within the scope of the invention and within the following claims.

### REFERENCES

| Patent document number | Issue Date | Name |
|---|---|---|
| 3,586,423 | Jun. 1971 | Zeltzer |
| 4,304,895 | Dec. 1981 | Loshaek |
| 4,390,676 | Jun. 1983 | Loshaek |
| 4,641,934 | Feb. 1987 | Freeman |
| 4,642,112 | Feb. 1987 | Freeman |
| 4,733,959 | Mar. 1988 | Claussen et al. |
| RE 33,477 | Dec. 1990 | Loshaek |
| 4,952,046 | Aug. 1990 | Stephens et al. |
| RE 38,402 | Jan. 2004 | Stephens et al. |
| 4,998,817 | Mar. 1991 | Zeltzer |
| 5,017,000 | May 1991 | Cohen |
| 5,117,306 | May 1992 | Cohen |
| 5,235,358 | Aug. 1993 | Mutzhas et al. |
| 5,617,154 | Apr. 1997 | Hoffman |
| 5,846,457 | Dec. 1998 | Hoffman |
| 6,089,711 | Jul. 2000 | Blankenbecler |
| 6,224,211 | May 2001 | Gordon |
| 6,338,559 | Jan. 2002 | Williams et al. |
| 6,786,603 | Sep. 2004 | Altman |
| 6,817,714 | Nov. 2004 | Altman |
| 7,097,301 | Aug. 2006 | Legerton et al. |
| 7,104,648 | Sep. 2006 | Dahi et al. |

Chou, Brian O D; Riding the Wave(front) to Super Vision, Review of Optometry, 140:04 (Apr. 15, 2003)
Vessel, Madeleine; Wavefront Technology in Eye Exams, All About Vision, (10/2006).
Thibos, Larry O D, et al., Design Principles and Limitations of Wavefront Guided Contact Lenses, Eye Contact Lens, S167-70 (Jan. 29, 2003).
Marcos, Susana, Refractive Surgery and Optical Aberrations, Optics and Photonics News, 22-25 (January 2001).

Pepose, David, Eyes wearing Nikes, The Washington Post (Aug. 8, 2006).

I claim:

1. A lens comprising:
a polymeric matrix material; and
at least one spectral blocking material, wherein the transmission of the lens is blocked below 455 nm and above 655 nm.

2. The lens of claim 1, wherein the polymeric material is shaped to form a contact lens, an intraocular lens, a spectacle lens or an optical insert.

3. The lens of claim 1, which is a PMMA contact lens, a rigid gas permeable (RGP) contact lens, a soft hydrogel contact lens, or a soft silicone-hydrogel contact lens.

4. The lens of claim 1, wherein the transmission of light through the lens between 400 and 455 nm is below 50%.

5. The lens of claim 1, wherein the transmission of light through the lens from 655 to 780 nm is below 50%.

6. The lens of claim 1, comprising a spectral blocking material which absorbs a portion of light in the ultraviolet range and a spectral blocking material which absorbs a portion of light in the infrared range.

7. The lens of claim 1, wherein all ultraviolet light is blocked.

8. The lens of claim 1, wherein the transmission of infrared light is 50% or less.

9. The lens of claim 1, wherein a spectral blocking material is polymerizable.

10. The lens of claim 1, wherein the infrared absorber is a metal complex.

11. The lens of claim 1 manufactured with wavefront technology.

12. The lens of claim 1 that achieves vision better than 20/20.

13. A method of making a lens that reduces chromatic aberration comprising:
providing a matrix polymer which is suitable for making an optical device; and
incorporating at least one spectral blocking material, wherein the lens blocks light below 455 nm and above 655 nm.

14. The method of claim 13, wherein the lens is a PMMA contact lens, a rigid gas permeable (RGP) contact lens, a soft hydrogel contact lens, or a soft silicone-hydrogel contact lens.

15. The method of claim 13, wherein the transmission of light through the lens between 400 and 455 nm is below 50%.

16. The method of claim 13, wherein the transmission of light through the lens from 655 to 780 nm is below 50%.

17. The method of claim 13, comprising a spectral blocking material which absorbs a portion of light in the ultraviolet range and a spectral blocking material which absorbs a portion of light in the infrared range.

18. A method of providing visual acuity greater than 20/20 comprising:
providing a lens of claim 1.

19. A lens that reduces chromatic aberration comprising: a polymeric matrix material, and at least one spectral blocking material, wherein the lens has at least a 70% light transmission from the region between 450 and 650 nm, and at most a 50% light transmission in the UV and IR ranges.
